(19) United States
(12) Patent Application Publication
(10) Pub. No.: US 2021/0280344 A1
(43) Pub. Date: Sep. 9, 2021

(54) Method for preparing NdFeB magnet powder

(71) Applicant: Yantai Shougang Magnetic Materials Inc, Yantai (CN)

(72) Inventors: Xiulei CHEN, Yantai (CN); Zhongjie PENG, Yantai (CN); Xiaonan ZHU, Yantai (CN); Kaihong DING, Yantai (CN)

(21) Appl. No.: 17/131,810

(22) Filed: Dec. 23, 2020

(30) Foreign Application Priority Data
Dec. 31, 2019 (CN) 201911421025.8

(51) Int. Cl. H01F 1/057; H01F 7/02

(52) U.S. Cl. CPC H01F 1/0571; H01F 7/02

(57) ABSTRACT

The present disclosure refers to a method of preparing a NdFeB magnet powder. The method includes a hydrogen treatment process including the steps of: a) charging NdFeB alloy flakes into a hydrogen treatment furnace, wherein the NdFeB alloy flakes include a neodymium-rich phase and a main phase; b) performing a hydrogen absorption by heating the hydrogen treatment furnace in a first stage to a temperature at which only the neodymium-rich phase undergoes a hydrogen absorption reaction, then introducing and maintaining hydrogen at a predetermined pressure until the hydrogen absorption of the neodymium-rich phase is finished, then stop heating of the hydrogen treatment furnace in a second stage, where the temperature falls to a temperature at which the main phase undergoes a hydrogen absorption reaction; and c) when the hydrogen absorption of step b) is finished, performing a vacuum dehydrogenation of the obtained coarse magnet powder.

### TECHNICAL FIELD

The present disclosure relates to a method for preparing a NdFeB magnetic powder.

### BACKGROUND

NdFeB magnets are widely used in storage equipment, electronic components, wind power generation, motors and other fields. Coercivity should be enhanced in order to increasing the work temperature of the magnet. At present, the most effective way to improve the coercivity of neodymium iron boron magnets is adding heavy rare earth elements like Dy, Tb, etc., to replace the Nd element in main phase. The mechanism is that Dy₂Fe₁₄B and Tb₂Fe₁₄B have a higher magnetocrystalline anisotropy field constant than Nd₂Fe₁₄B. However, the reserves of heavy rare earth elements are extremely limited and expensive, which will greatly increase the material cost of magnets and is not in accordance with the strategic policy of sustainable development. In order to reduce the amount of heavy rare earth elements, the grain boundary diffusion method is used to infiltrate the magnets with heavy rare earth elements, which can significantly improve the coercivity of the magnets under the condition of using a small amount of heavy rare earth elements. However, the process of the diffusion method is complicated, which additionally increases the processing cost, and the utilization rate of raw materials is not high.

In order to improve performance under the premise of controlling the cost of raw materials, optimizing the manufacturing process has become an important method. The present technology of preparing sintered NdFeB magnet includes steps of strip casting, hydrogen treatment, jet-milling, orientation and molding, sintering and aging. In recent years, companies and research institutions have done a lot of research and improvement on hydrogen treatment and jet milling processes. The hydrogen treatment process is to subject the strip casting flakes at a certain hydrogen pressure in the hydrogen treatment furnace. The main phase and the neodymium-rich phase react with the hydrogen, resulting in intergranular fracture and transgranularity fracture leading to a powder with a particle size of tens to hundreds of microns. The way of hydrogen treatment will affect the particle size distribution, grinding efficiency, and magnetic powder yield during the jet milling process. These will play an important role in the performance of the final magnet and the material cost.

In Chinese patent CN105405563B, protective gas is inserted together with hydrogen into the hydrogen treatment furnace during the hydrogen absorption process. Due to the presence of the protective gas, the hydrogen molecules are distributed more uniform in the furnace cavity, thereby making the hydrogen decrepitation more thorough. In Chinese patent CN106683814B, no dehydrogenation was performed after the hydrogen decrepitation process. The hydrogen treated coarse alloy powders was firstly pulverized into fine magnetic powders by jet milling process and then the hydrogen was degassed. The advantage of this method is that the presence of a large amount of hydrogen in the alloy during jet milling can prevent the powders from oxidation and also the ribbon is more brittle to be grinded.

Although the present hydrogen treatment process has been greatly improved, there are still some shortcomings. For example, in a conventional hydrogen treatment process, after hydrogen is introduced at room temperature, the alloy flakes start to absorb hydrogen and occur exothermic reaction, and the temperature can reach about 200° C. At this temperature, both the main phase and the neodymium-rich phase can react with hydrogen. But because the reaction temperature is relatively low and the main phase is wrapped by the neodymium-rich phase, it is difficult for hydrogen to penetrate into the center, which results in uneven hydrogen absorption. The different decrepitation effect relying on location will make it difficult to grind the alloy by jet milling and also the neodymium-rich phase coated on the outer side of the main phase is easy to be grind off. The specific gravity of ultrafine powder with a particle size of less than 1 micron is relatively high. The ultrafine powder is easily oxidized and nitrided. This part of ultrafine powders is usually not used to prepare magnets since it is easily oxidized and nitrided. So this part of ultrafine powder will be filtered out by the cyclone separator of the jet mill equipment and lowers the material utilization rate.

### SUMMARY

The disclosure provides a method of preparing NdFeB magnetic powders. The neodymium-rich phase and the main phase of the NdFeB alloy are respectively crushed under control of the hydrogen absorption temperature during hydrogen treatment process. A magnetic powder with uniform particle size distribution is obtained after jet milling process. The grinding efficiency is improved. This will enhance also the magnetic properties of the NdFeB magnet and also will reduce the material cost.

According to the present disclosure, there is provided a method of preparing a NdFeB magnet powder. The method includes a hydrogen treatment process including the steps of:

a) charging NdFeB alloy flakes into a hydrogen treatment furnace, wherein the NdFeB alloy flakes include a neodymium-rich phase and a main phase;

b) performing a hydrogen absorption by heating the hydrogen treatment furnace in a first stage to a temperature at which only the neodymium-rich phase undergoes a hydrogen absorption reaction, then introducing and maintaining hydrogen at a predetermined pressure until the hydrogen absorption of the neodymium-rich phase is finished, then stop heating of the hydrogen treatment furnace in a second stage, where the temperature falls to a temperature at which the main phase undergoes a hydrogen absorption reaction; and

c) when the hydrogen absorption of step b) is finished, performing a vacuum dehydrogenation of the obtained coarse magnet powder.

That is, the alloy flakes prepared in step a) are put into a hydrogen treatment furnace for hydrogen treatment. The hydrogen treatment furnace may be firstly filled with argon gas. Then hydrogen gas is introduced—in particular to replace the argon—under a certain temperature condition. This first stage is to subject the neodymium-rich phase hydrogen absorption reaction at high temperature. A second stage, where heating is stopped, is to subject the main phase hydrogen absorption reaction under lower temperature.

According to an embodiment, in the first stage of step b) of the hydrogen treatment process, the hydrogen treatment furnace is heated to a temperature between 390° C. to 480° C. According to another embodiment, the heating to the temperature at which only the neodymium-rich phase undergoes the hydrogen absorption reaction is performed under argon and, when the temperature reaches said temperature, argon is removed from the hydrogen treatment furnace and hydrogen introduction is started. According to another embodiment, a hydrogen flow into the hydrogen treatment furnace is controlled such that a pressure in the hydrogen treatment furnace is maintained between 0.15 MPa to 0.20 MPa until the hydrogen flow stops. According to another embodiment, hydrogen is replaced by argon when the temperature is 220° C. or below, in particular when the temperature is below 130° C. Each of the before mentioned embodiments could be independently combined. The hydrogen treatment process may preferably include each of the before mentioned embodiments.

That is, in step b), for the first stage of the hydrogen absorption reaction, the hydrogen treatment furnace may be firstly heated to a high temperature between 390° C. to 480° C., and hydrogen is introduced to maintain the pressure in the hydrogen treatment furnace between 0.15 MPa to 0.20 MPa until the hydrogen flow is no longer flowing. Then the heating is stopped and the temperature starts to drop. When the temperature is cooled to 220° C. or below, the hydrogen is replaced by argon.

In the hydrogen absorption step, hydrogen is introduced at a high temperature, in particular between 390° C. and 480° C. At this temperature, only a neodymium-rich phase of the alloy flakes can undergo hydrogen absorption reaction, while the main phase (composed of Re2Fe14B and being wrapped by the neodymium-rich phase) does not undergo hydrogen absorption reaction. At this time, the alloy flakes only absorb hydrogen at the grain boundary, causing intergranular fracture. Due to the higher reaction temperature, the reaction speed is fastened and the fracture along the crystal is more thorough. In the subsequent cooling process, when the temperature drops below in particular below 235° C., the main phase begins to effectively absorb hydrogen, that is, the reaction Re₂Fe₁₄B+y/2H₂→Re₂Fe₁₄BHy occurs. At this time, the alloy flakes undergo transgranular fracture when the main phase absorbs hydrogen. Due to the intergranular fracture caused by the hydrogen absorption of the neodymium-rich phase in the first stage, the alloy flakes have been broken along the grain boundary. In the second stage of the hydrogen absorption process, the main phase can directly contact with hydrogen to allow thorough reaction and transgranular fracture whereby the main phase is broken more uniformly and thoroughly. Moreover, using argon to replace hydrogen at a lower temperature will support hydrogen absorption more thoroughly in the main phase and have a better crushing effect on the main phase.

After performing hydrogen treatment on the alloy flakes by the method of the present disclosure, magnetic powders with narrower particle size distribution can be obtained in the subsequent jet milling process. Also in the jet milling process, the grinding efficiency and the magnetic powder yield are improved. The present method not only improves the material utilization rate, but also lays the foundation for enhancing the magnetic properties of Nd—Fe—B magnet. The yield of magnetic powder after jet milling process may be no less than 99.1%.

According to another embodiment, in step c) of the hydrogen treatment process, the vacuum dehydrogenation is performed by heating to a temperature of 550° C. or more. The vacuum dehydrogenation may be performed for at least 5 h.

According to another embodiment, the NdFeB alloy flakes are prepared from raw materials by a strip casting process.

According to another embodiment, a course magnetic powder obtained by the hydrogen treatment process is pulverized by a jet milling process. A carrier gas of the jet milling process may be nitrogen or argon.

### BRIEF DESCRIPTION OF THE DRAWINGS

FIG. 1 is a schematic diagram of the hydrogen treatment process, which is part of the method of preparing a NdFeB magnet powder, according to an embodiment of the present disclosure.

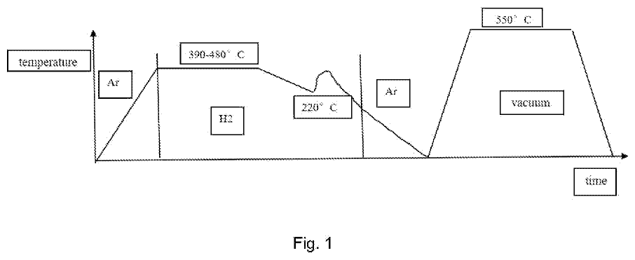

### DETAILED DESCRIPTION OF THE EMBODIMENTS

The examples set forth below provide illustrations of the present disclosure. These examples shall not limit the scope of the present disclosure.

A NdFeB magnet (also known as NIB or Neo magnet) is the most widely used type of rare-earth magnet. It is a permanent magnet made from an alloy of neodymium, iron, and boron to form the Nd₂Fe₁₄B tetragonal crystalline structure as a main phase. Besides, the microstructure of NdFeB magnets includes usually a Nd-rich phase. The alloy may include further elements in addition to or partly substituting neodymium and iron, which is however not important for the present disclosure far as the microstructure includes the main phase and the Nd-rich phase. In other words, a NdFeB magnet at presently understood covers all such alloy compositions. Because of different manufacturing processes, NdFeB magnets are divided into two subcategories, namely sintered NdFeB magnets and bonded NdFeB magnets. Conventional manufacturing processes for both subcategories usually include the sub-step of preparing NdFeB powders from NdFeB alloy flakes obtained by a strip casting process.

In this respect, hydrogen embrittlement is a process by which hydride-forming metals become brittle, even fracture due to the penetration of hydrogen gas, and mechanical strength of relevant material will dramatically decrease because of hydrogen embrittlement. Hydrogen gas has been widely used in powder making process of NdFeB magnet. The main phase and Nd-rich phase of NdFeB casting piece will generate lattice expansion after absorbed hydrogen, hence cause the integranular fracture and transgranular fracture, finally lead to the pulverization.

Also the present disclosure refers to a method of preparing a NdFeB magnet powder using the process of hydrogen embrittlement. The method includes a specific hydrogen treatment process including the steps of:

a) charging NdFeB alloy flakes into a hydrogen treatment furnace, wherein the NdFeB alloy flakes include a neodymium-rich phase and a main phase;

b) performing a hydrogen absorption by heating the hydrogen treatment furnace in a first stage to a temperature at which only the neodymium-rich phase undergoes a hydrogen absorption reaction, then introducing and maintaining hydrogen at a predetermined pressure until the hydrogen absorption of the neodymium-rich phase is finished, then stop heating of the hydrogen treatment furnace in a second stage, where the temperature falls to a temperature at which the main phase undergoes a hydrogen absorption reaction; and

c) when the hydrogen absorption of step b) is finished, performing a vacuum dehydrogenation of the obtained coarse magnet powder.

In the first stage of step b) of the hydrogen treatment process, the hydrogen treatment furnace may be heated to a temperature between 390° C. to 480° C. The heating to the temperature at which only the neodymium-rich phase undergoes the hydrogen absorption reaction may be performed under argon and, when the temperature reaches said temperature, argon may be removed from the hydrogen treatment furnace and hydrogen introduction may be started. A hydrogen flow into the hydrogen treatment furnace may be controlled such that a pressure in the hydrogen treatment furnace is maintained between 0.15 MPa to 0.20 MPa until the hydrogen flow stops. Hydrogen may be replaced by argon when the temperature is 220° C. or below, in particular when the temperature is below 130° C.

### Example 1

A raw material including Nd—Pr being present 32.0 wt. %, B being present 0.98 wt. %, Co being present 1.0 wt. %, Al being present 0.3 wt. %, Cu being present 0.10 wt. %, Ga being present 0.10 wt. %, and Fe being present as a balance, and unavoidable impurities is made into alloy flakes by a strip casting process.

The alloy flakes are put into a hydrogen treatment furnace. The temperature is raised to 390° C. in an argon atmosphere, and then hydrogen is introduced to replace argon. The hydrogen pressure is maintained at 0.15 MPa, and the hydrogen flow is monitored. The heating is stopped and cooling is started when the hydrogen flow stops. The hydrogen is replaced by argon when the temperature is cooled down to 220° C. and cooling down is continued until room temperature is reached. Then the temperature is raised to 550° C. for a duration of 5 hours for dehydrogenation while vacuumizing. Then the course magnetic powder of the hydrogen treatment is pulverized by subjecting a jet milling process using nitrogen as a carrier gas. The pressure in the grinding chamber is set to 0.40 MPa, the speed of the classifying wheel is 2700 rpm, and the mass of feed is 10.0 kg.

Particle size distribution of magnetic powder is tested after being pulverized. The grinding efficiency, the proportion of ultrafine powder, the proportion of residual materials in the grinding chamber, and the yield of magnetic powder is separately calculated.

### Example 2

A raw material including Nd—Pr being present 32.0 wt. %, B being present 0.98 wt. %, Co being present 1.0 wt. %, Al being present 0.3 wt. %, Cu being present 0.10 wt. %, Ga being present 0.10 wt. %, and Fe being present as a balance, and unavoidable impurities is made into alloy flakes by a strip casting process.

The alloy flakes are put into a hydrogen treatment furnace. The temperature is raised to 480° C. in an argon atmosphere, and then hydrogen is introduced to replace argon. The hydrogen pressure is maintained at 0.20 MPa, and the hydrogen flow is monitored. The heating is stopped and cooling is started when the hydrogen flow stops. The hydrogen is replaced by argon when the temperature is cooled down to 100° C. and cooling down is continued until room temperature is reached. Then the temperature is raised to 550° C. for a duration of 5 hours for dehydrogenation while vacuumizing. Then the course magnetic powder of the hydrogen treatment is pulverized by subjecting a jet milling process using nitrogen as a carrier gas. The pressure in the grinding chamber is set to 0.40 MPa, the speed of the classifying wheel is 2700 rpm, and the mass of feed is 10.0 kg.

Particle size distribution of magnetic powder is tested after being pulverized. The grinding efficiency, the proportion of ultrafine powder, the proportion of residual materials in the grinding chamber, and the yield of magnetic powder is separately calculated.

### Example 3

A raw material including Nd—Pr being present 32.0 wt. %, B being present 0.98 wt. %, Co being present 1.0 wt. %, Al being present 0.3 wt. %, Cu being present 0.10 wt. %, Ga being present 0.10 wt. %, and Fe being present as a balance, and unavoidable impurities is made into alloy flakes by a strip casting process.

The alloy flakes are put into a hydrogen treatment furnace. The temperature is raised to 450° C. in an argon atmosphere, and then hydrogen is introduced to replace argon. The hydrogen pressure is maintained at 0.18 MPa, and the hydrogen flow is monitored. The heating is stopped and cooling is started when the hydrogen flow stops. The hydrogen is replaced by argon when the temperature is cooled down to 130° C. and cooling down is continued until room temperature is reached. Then the temperature is raised to 550° C. for a duration of 5 hours for dehydrogenation while vacuumizing. Then the course magnetic powder of the hydrogen treatment is pulverized by subjecting a jet milling process using nitrogen as a carrier gas. The pressure in the grinding chamber is set to 0.40 MPa, the speed of the classifying wheel is 2700 rpm, and the mass of feed is 10.0 kg.

Particle size distribution of magnetic powder is tested after being pulverized. The grinding efficiency, the proportion of ultrafine powder, the proportion of residual materials in the grinding chamber, and the yield of magnetic powder is separately calculated.

Experimental data of Implementing Examples 1, 2, and 3 are summarized in Table 1.

TABLE 1
data of implementing examples

| | | | | | | proportion | proportion | yield of |
|---|---|---|---|---|---|---|---|---|
| | | | | | grinding | of ultrafine | of residual | magnetic |
| | X₁₀ | X₅₀ | X₉₀ | | efficiency | powder | materials | powder |
| | (μm) | (μm) | (μm) | X₉₀/X₁₀ | (kg/h) | (%) | (%) | (%) |
| Example 1 | 1.43 | 3.07 | 5.13 | 3.59 | 2.13 | 0.5 | 0.4 | 99.1 |
| Example 2 | 1.49 | 3.05 | 5.03 | 3.38 | 2.35 | 0.3 | 0.2 | 99.5 |
| Example 3 | 1.46 | 3.08 | 5.13 | 3.51 | 2.28 | 0.4 | 0.3 | 99.3 |

In Table 1, X10 refers to the particle size when the cumulative particle size distribution of the sample reaches 10%, and its physical meaning is that the particle size smaller than it accounts for 10%. X50 and X90 have similar meanings. X50 is also called median diameter. In the Nd—Fe—B industry, if X50 is close, the smaller the value of X90/X10, the narrower the particle size distribution, the more uniform is the particle size.

### Comparative Example 1

A raw material including Nd—Pr being present 32.0 wt. %, B being present 0.98 wt. %, Co being present 1.0 wt. %, Al being present 0.3 wt. %, Cu being present 0.10 wt. %, Ga being present 0.10 wt. %, and Fe being present as a balance, and unavoidable impurities is made into alloy flakes by a strip casting process.

The alloy flakes are put into a hydrogen treatment furnace. Hydrogen is introduced at room temperature, hydrogen pressure is maintained at 0.20 Mpa, and the hydrogen flow is monitored. When the hydrogen flow stop, hydrogen is replaced by argon. Then it is continued to cool down until room temperature. And then it is heat up to 550° C. for a duration of 5 hours for dehydrogenation while vacuumizing. Then the alloy is pulverized by subjecting a jet milling process using a carrier gas of nitrogen. The pressure in the grinding chamber is set to 0.40 MPa, the speed of the classifying wheel is 2700 rpm, and the mass of feed is 10.0 kg. Particle size distribution of magnetic powder is tested after being pulverized. The grinding efficiency, the proportion of ultrafine powder, the proportion of residual materials in the grinding chamber, and the yield of magnetic powder is separately calculated.

Compared with process of the Implementing Examples, in Comparative Example 1 hydrogen is introduced at room temperature, hydrogen decrepitation of the main phase and the neodymium-rich phase is carried out simultaneously.

### Comparative Example 2

A raw material including Nd—Pr being present 32.0 wt. %, B being present 0.98 wt. %, Co being present 1.0 wt. %, Al being present 0.3 wt. %, Cu being present 0.10 wt. %, Ga being present 0.10 wt. %, and Fe being present as a balance, and unavoidable impurities is made into alloy flakes by a strip casting process.

The alloy flakes are put into a hydrogen treatment furnace. The temperature is raised to 350° C. in an argon atmosphere, and then hydrogen is introduced to replace argon. The hydrogen pressure is maintained at 0.20 Mpa, and the hydrogen flow is monitored. Heating is stopped and cooling started when the hydrogen flow stops. Hydrogen is replaced by argon when the temperature is cooled to 100° C., then continue to cool down until room temperature. And then it is heat up to 550° C. for a duration of 5 hours for dehydrogenation while vacuumizing. Then the alloy is pulverized by subjecting a jet milling process using a carrier gas of nitrogen. The pressure in the grinding chamber is set to 0.40 MPa, the speed of the classifying wheel is 2700 rpm, and the mass of feed is 10.0 kg.

Particle size distribution of magnetic powder is tested after being pulverized. The grinding efficiency, the proportion of ultrafine powder, the proportion of residual materials in the grinding chamber, and the yield of magnetic powder is separately calculated.

Compared with process of the Implementing Examples, temperature of introducing hydrogen in Comparative Example 2 is lower than which the present disclosure has announced.

### Comparative Example 3

A raw material including Nd—Pr being present 32.0 wt. %, B being present 0.98 wt. %, Co being present 1.0 wt. %, Al being present 0.3 wt. %, Cu being present 0.10 wt. %, Ga being present 0.10 wt. %, and Fe being present as a balance, and unavoidable impurities is made into alloy flakes by a strip casting process.

The alloy flakes are put into a hydrogen treatment furnace. The temperature is raised to 480° C. in an argon atmosphere, and then hydrogen is introduced to replace argon. The hydrogen pressure is maintained at 0.20 Mpa, and the hydrogen flow is monitored. Heating is stopped and cooling started when the hydrogen flow stops. Hydrogen is replaced by argon when the temperature cools down to 300° C., then it is continued to cool down until room temperature. And then it is heat up to 550° C. for a duration of 5 hours for dehydrogenation while vacuumizing. Then the alloy is pulverized by subjecting a jet milling process using a carrier gas of nitrogen. The pressure in the grinding chamber is set to 0.40 MPa, the speed of the classifying wheel is 2700 rpm, and the mass of feed is 10.0 kg.

Particle size distribution of magnetic powder is tested after being pulverized. The grinding efficiency, the proportion of ultrafine powder, the proportion of residual materials in the grinding chamber, and the yield of magnetic powder is separately calculated.

Compared with process of the Implementing Examples, temperature of replacing hydrogen by argon is higher than which the present disclosure has announced.

Experimental data of Comparative Examples 1, 2, and 3 are summarized in Table 2.

TABLE 2
data of Comparative Examples 1-3

| | | | | | | proportion | proportion | yield of |
|---|---|---|---|---|---|---|---|---|
| | | | | | grinding | of ultrafine | of residual | magnetic |
| | X₁₀ | X₅₀ | X₉₀ | | efficiency | powder | materials | powder |
| | (μm) | (μm) | (μm) | X₉₀/X₁₀ | (kg/h) | (%) | (%) | (%) |
| Comparative | 1.34 | 3.05 | 5.29 | 3.95 | 1.85 | 0.7 | 0.6 | 98.7 |
| Example 1 | | | | | | | | |
| Comparative | 1.39 | 3.07 | 5.25 | 3.78 | 2.05 | 0.6 | 0.5 | 98.9 |
| Example 2 | | | | | | | | |
| Comparative | 1.29 | 3.09 | 5.61 | 4.35 | 1.58 | 0.7 | 0.9 | 98.4 |
| Example 3 | | | | | | | | |

In the implementing examples, the values of X90/X10 are all less than or equal to 3.59. When X50 is close, it indicates that the magnetic powder has a narrow particle size distribution range. The grinding efficiency is higher than 2.13 kg/h, and the magnetic powder yield is higher than 99.1%, indicating that the alloy flakes can be crushed more thoroughly and uniformly by the present method. In the process of jet milling, the hydrogen-treated alloy flakes are easy to be pulverized to the target particle size, and the crushing of the alloy can better along the cracks produced by the hydrogen treatment without grinding away the neodymium-rich phase outside of the main phase. Therefore, the proportion of ultrafine powder and the proportion of residual materials in the milling chamber are relatively low. Implementing Examples 1, 2, and 3 show that in the cooling process of hydrogen absorption, if reduce the temperature of replacing hydrogen with argon, the particle size distribution after jet milling will be narrower. At the same time, the grinding efficiency and the magnetic powder yield get higher. These show that the lower the temperature of replacing hydrogen by argon, the reaction is more thoroughly and the main phase be crushed more sufficiently. This will be better for pulverizing alloy by jet milling process.

In Comparative Example 1, hydrogen treatment was performed on the alloy flakes by traditional process. Compared with implementing samples, the X90/X10 value was higher, and the grinding efficiency and the magnetic powder yield were both lower. This may be because in the traditional hydrogen absorption process, hydrogen was introduced into the furnace without preheating the alloy flakes. Then the hydrogen absorption reactions of the main phase and the neodymium-rich phase were proceeded simultaneously. The main phase and hydrogen cannot be in full contact, then transgranularity fracture is not thorough and uniform, which makes it relatively difficult to break the main phase particles during the jet milling process. For there are not enough cracks in the main phase, it take longer time and more collisions between particles to be broken to the target particle size. This will cause the neodymium-rich phase around the main phase particles to be abraded and produce a large amount of ultrafine powder. This is a waste of rare earth raw materials. At the same time, the difficulty of breaking the main phase will increase the residual material in the grinding chamber, and the final magnetic powder yield will decrease.

Compared with the Implementing Examples, the temperature of the hydrogen absorption reaction of the neodymium-rich phase in Comparative Example 2 is 350° C., which is lower. That makes the both the particle uniformity and the magnetic powder yield after grinding are lower than the value in the Implementing Examples.

In the cooling process of the hydrogen treatment in Comparative Example 3, argon was used to replace hydrogen at 300° C., resulting in no effective hydrogen decrepitation of the main phase, so the particle size distribution, grinding efficiency, and magnetic powder yield after grinding get worse.

In summary, using the method of the present disclosure to perform hydrogen treatment on the neodymium-iron-boron alloy and then be pulverized into powders by jet milling process has higher grinding efficiency and higher magnetic powder yield, and also the magnetic powder particle size distribution is more uniform. It can significantly improve the performance of neodymium-iron-boron magnets and the utilization rate of raw materials.

What is claimed is:

1. A method of preparing a NdFeB magnet powder, the method including a hydrogen treatment process including the steps of:
a) charging NdFeB alloy flakes into a hydrogen treatment furnace, wherein the NdFeB alloy flakes include a neodymium-rich phase and a main phase;
b) performing a hydrogen absorption by heating the hydrogen treatment furnace in a first stage to a temperature at which only the neodymium-rich phase undergoes a hydrogen absorption reaction, then introducing and maintaining hydrogen at a predetermined pressure until the hydrogen absorption of the neodymium-rich phase is finished, then stop heating of the hydrogen treatment furnace in a second stage, where the temperature falls to a temperature at which the main phase undergoes a hydrogen absorption reaction; and
c) when the hydrogen absorption of step b) is finished, performing a vacuum dehydrogenation of the obtained coarse magnet powder.

2. The method of claim 1, wherein, in the first stage of step b) of the hydrogen treatment process, the hydrogen treatment furnace is heated to a temperature between 390° C. to 480° C.

3. The method of claim 1, wherein, in the first stage of step b) of the hydrogen treatment process, the heating to the temperature at which only the neodymium-rich phase undergoes the hydrogen absorption reaction is performed under argon and, when the temperature reaches said temperature, argon is removed from the hydrogen treatment furnace and hydrogen introduction is started.

4. The method of claim 2, wherein, in the first stage of step b) of the hydrogen treatment process, the heating to the temperature at which only the neodymium-rich phase undergoes the hydrogen absorption reaction is performed under argon and, when the temperature reaches said temperature, argon is removed from the hydrogen treatment furnace and hydrogen introduction is started.

5. The method of claim 1, wherein, in the first stage of step b) of the hydrogen treatment process, a hydrogen flow into the hydrogen treatment furnace is controlled such that a pressure in the hydrogen treatment furnace is maintained between 0.15 MPa to 0.20 MPa until the hydrogen flow stops.

6. The method of claim 2, wherein, in the first stage of step b) of the hydrogen treatment process, a hydrogen flow into the hydrogen treatment furnace is controlled such that a pressure in the hydrogen treatment furnace is maintained between 0.15 MPa to 0.20 MPa until the hydrogen flow stops.

7. The method of claim 3, wherein, in the first stage of step b) of the hydrogen treatment process, a hydrogen flow into the hydrogen treatment furnace is controlled such that a pressure in the hydrogen treatment furnace is maintained between 0.15 MPa to 0.20 MPa until the hydrogen flow stops.

8. The method of claim 4, wherein, in the first stage of step b) of the hydrogen treatment process, a hydrogen flow into the hydrogen treatment furnace is controlled such that a pressure in the hydrogen treatment furnace is maintained between 0.15 MPa to 0.20 MPa until the hydrogen flow stops.

9. The method of claim 1, wherein, in the second stage of step b) of the hydrogen treatment process, hydrogen is replaced by argon when the temperature is 220° C. or below, in particular when the temperature is below 130° C.

10. The method of claim 2, wherein, in the second stage of step b) of the hydrogen treatment process, hydrogen is replaced by argon when the temperature is 220° C. or below, in particular when the temperature is below 130° C.

11. The method of claim 3, wherein, in the second stage of step b) of the hydrogen treatment process, hydrogen is replaced by argon when the temperature is 220° C. or below, in particular when the temperature is below 130° C.

12. The method of claim 4, wherein, in the second stage of step b) of the hydrogen treatment process, hydrogen is replaced by argon when the temperature is 220° C. or below, in particular when the temperature is below 130° C.

13. The method of claim 1, wherein, in step c) of the hydrogen treatment process, the vacuum dehydrogenation is performed by heating to a temperature of 550° C. or more.

14. The method of claim 2, wherein, in step c) of the hydrogen treatment process, the vacuum dehydrogenation is performed by heating to a temperature of 550° C. or more.

15. The method of claim 3, wherein, in step c) of the hydrogen treatment process, the vacuum dehydrogenation is performed by heating to a temperature of 550° C. or more.

16. The method of claim 4, wherein, in step c) of the hydrogen treatment process, the vacuum dehydrogenation is performed by heating to a temperature of 550° C. or more.

17. The method of claim 1, wherein the NdFeB alloy flakes are prepared from raw materials by a strip casting process.

18. The method claim 1, wherein a course magnetic powder obtained by the hydrogen treatment process is pulverized by a jet milling process.

19. The method of claim 18, wherein a carrier gas of the jet milling process is nitrogen or argon.
